(19) United States
(12) Patent Application Publication
(10) Pub. No.: US 2013/0038297 A1
(43) Pub. Date: Feb. 14, 2013

(54) BATTERY CHARGING CONTROL DEVICE AND METHOD OF IMPLEMENTING THE SAME

(71) Applicants: Zhao SANG, Xi'an City (CN); Zheng LI, Shenzhen (CN); Chih-Yuan HSU, Hsinchu City (TW); Chi-Ming LEE, Hsinchu City (TW); Cheng-Chuan TSAI, Hsinchu City (TW); Shieh-Chen WANG, Taichung City (TW)

(72) Inventors: Zhao SANG, Xi'an City (CN); Zheng LI, Shenzhen (CN); Chih-Yuan HSU, Hsinchu City (TW); Chi-Ming LEE, Hsinchu City (TW); Cheng-Chuan TSAI, Hsinchu City (TW); Shieh-Chen WANG, Taichung City (TW)

(73) Assignee: MEDIATEK SINGAPORE PTE. LTD., Singapore (SG)

(21) Appl. No.: 13/572,109

(22) Filed: Aug. 10, 2012

Related U.S. Application Data
(60) Provisional application No. 61/522,042, filed on Aug. 10, 2011.

(30) Foreign Application Priority Data
Mar. 15, 2012 (CN) 201210068865.2

(51) Int. Cl. H02J 7/00

(52) U.S. Cl. 320/145; 320/162

(57) ABSTRACT

The invention discloses a charging control method for adjusting a charging current of a charging device, including monitoring a working voltage of the charging device, wherein the working voltage includes a voltage difference between a charging voltage and a battery voltage; adjusting the charging current of the charging device dynamically according to the working voltage of the charging device to maintain a working power of the charging device within a predetermined power range.

### CROSS-REFERENCE TO RELATED APPLICATIONS

This application claims the benefit of U.S. Provisional Application No. 61/522,042, filed on Aug. 10, 2011 and Invention Patent Application in China No. 201210068865.2, filed on Mar. 15, 2012, the contents of which are incorporated herein by reference.

### BACKGROUND OF THE INVENTION

1. Field of the Invention

The present invention relates to electric charging, and in particular relates to charging control methods, charging control devices, charging systems, and portable devices.

2. Description of the Related Art

Portable devices, for example, cell phones, are widely used in daily life of users.

The portable devices usually use rechargeable batteries as power sources. Due to the size of the portable devices and limited capacity of the batteries, users recharge the batteries frequently.

A typical way of charging the battery is by constant current. During the charging period, the charging current to the battery is maintained at a constant level. To prevent the charging device from damage due to overheating when applied with the constant current charging, the working power of the charging device is limited by the rated power. The working power of the charging device varies according to the battery voltage. When the voltage applied to the charging device is constant; the working power gradually decreases while the battery voltage increases. This results in a longer charging time as the power efficiency drops. When the charging voltage is unstable, the higher the charging voltage is, the larger the working power of the charging device is. The working power of the charging device exceeds the rated voltage when the charging voltage is increased to over a certain level, which may cause damage to the charging device.

To conclude, the traditional way of charging with a constant current has problems such as: the working power varies with the charging voltage and the battery voltage; charging efficiency is low due to decreased working power, and damage may be caused by overheating when the working power is too high.

### BRIEF SUMMARY OF THE INVENTION

To improve the problem of traditional charging methods, a charging control method, a charging control device, a charging system and a portable device are introduced.

In one embodiment, the invention discloses a charging control method for adjusting a charging current of a charging device. The charging control method comprises monitoring a working voltage of the charging device, wherein the working voltage comprises a voltage difference between a charging voltage and a battery voltage; and dynamically adjusting the charging current of a charging device according to the working voltage of the charging device to maintain a working power of the charging device within a predetermined power range.

In another embodiment, the invention further discloses a charging control device. The charging control device comprises a voltage detection module and a current adjusting module. The voltage detection module is utilized for monitoring a working voltage of the charging device, wherein the working voltage comprises a voltage difference between a charging voltage and a battery voltage. The current adjusting module is utilized for adjusting a charging current of a charging device dynamically according to the working voltage of the charging device.

The invention also discloses a charging system, comprising a charging device and the charging control device connected to the charging device and a portable device, comprising the charging control device.

### BRIEF DESCRIPTION OF THE DRAWINGS

The present invention can be more fully understood by reading the subsequent detailed description and examples with references made to the accompanying drawings, wherein:

FIG. 1 is a flow diagram of a charging control method of a first embodiment according to the invention;

FIG. 2A is a flow diagram of a charging control method of a second embodiment according to the invention;

FIG. 2B is a schematic view of settings of charging voltage levels without hysteresis characteristics in an embodiment according to the invention;

FIG. 2C is a schematic view of settings of charging voltage levels with hysteresis characteristics in an embodiment according to the invention;

FIG. 3A is a flow diagram of a charging control method of a third embodiment according to the invention;

FIG. 3B is a schematic view of charging current comparisons between the embodiment and the constant current charging;

FIG. 3C is a schematic view of charging time comparisons between the embodiment and the constant current charging;

FIG. 4A is a flow diagram of a charging control method in the fourth embodiment;

FIG. 4B is a schematic view of I-V characteristic when using adjusting current according to the current duty cycle;

FIG. 5 is a flow diagram of a charging control method in the fifth embodiment;

FIG. 6 is a flow diagram of a charging control method in the sixth embodiment;

FIG. 7 is a flow diagram of a charging control method in the seventh embodiment;

FIG. 8 is a flow diagram of a charging control method in the eighth embodiment;

FIG. 9 is a flow diagram of a charging control method in the ninth embodiment;

FIG. 10A is a schematic view of a charging system in the eleventh embodiment;

FIG. 10B is a schematic view of an embodiment of the charging system of the invention.

### DETAILED DESCRIPTION OF THE INVENTION

The following description is some embodiments of carrying out the invention. This description is made for the purpose of illustrating the general principles of the invention and should not be taken in a limiting sense. The scope of the invention is best determined by reference to the appended claims.

To solve the problem of large power fluctuations when batteries are operated by traditional methods for battery charging, the invention discloses a charging control method, dynamically adjusting the charging current of the charging device to maintain the working power of the charging device to be within a predetermined range, for example, a rated power, to prevent the charging device from damage due to high working power, and to improve the charging efficiency.

In the embodiments of the invention, the charging device is a conduction device in the charging circuit, and the charging device determines the level of the charging current. The charging device can be a Metal-Oxide-Semiconductor (MOS) circuit, more specifically, a Bipolar Junction Transistor (BJT), a Metal-Oxide-Semiconductor Field-Effect Transistor (MOSFET), or a P-channel MOS (PMOS) circuit. The PMOS circuit may be constructed by two PMOS devices, a PMOS device and a diode, or a circuit comprising a PMOS device and a BJT. The charging device may be built in the charging circuits of portable devices, or be built in independent charging devices. In the embodiments, the charging devices are built in the portable devices.

In the embodiment, maintaining the working power within a predetermined power range means the working power of the charging device is the same as the predetermined power, or slightly larger or smaller than the predetermined power. When charging the battery of the portable device, the portable device is connected to the charger device, and the charger device provides a charging voltage to the charging device of the portable device. An output terminal of the charging device is connected to the battery to be charged. The charging device charges the battery according to the charging voltage.

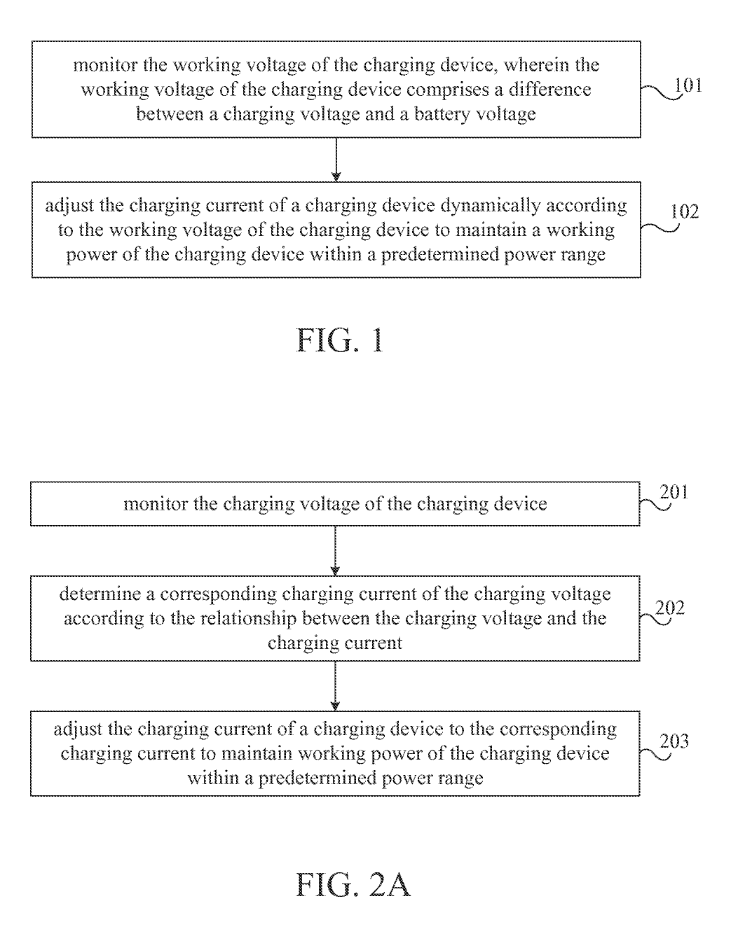

FIG. 1 is a flow diagram of a charging control method in an embodiment of the invention. The charging control method of the embodiment adjusts the charging current of the charging device, maintaining the power at the predetermined power range during the charging period. More specifically, as shown in FIG. 1, the charging control method of the embodiment comprises the following steps.

At a step 101, the working voltage of the charging device is monitored, wherein the working voltage of the charging device comprises a difference between a charging voltage and a battery voltage.

At a step 102, the charging current of a charging device is dynamically adjusted according to the working voltage of the charging device to maintain a working power of the charging device to be within a predetermined power range.

In the embodiment, the charging control device in a portable device monitors the working voltage comprising a difference between a charging voltage and a battery voltage in the step 101, and adjusts the charging current of the charging device dynamically according to the working voltage of the charging device to maintain a working power of the charging device to be within a predetermined power range in the step 102. During a battery charging period, the charging device is working at the predetermined power range to achieve a certain charging efficiency and to prevent it from damage.

In some conditions the charging voltage and the battery voltage can be set to a fixed value, and the working voltage of the charging device comprises the difference between the charging voltage and the battery voltage. Therefore, when the charging voltage is set to a constant level, the charging current may be adjusted dynamically according to the battery voltage. In another hand, when the battery voltage is set to a constant level, the charging current may be adjusted dynamically according to the charging voltage.

Also, in some applications, the charging current is adjusted according to the deviation of the charging voltage or the deviation of the battery voltage to achieve a certain charging efficiency and to prevent it from damage.

To conclude, in the embodiment, the invention provides a charging control method, which is utilized for adjusting the charging current of the charging device to maintain the power of the charging device to be within a predetermined power range (such as a rated power). The method prevents the charging efficiency from dropping caused by a low working power, and prevents the charging device from being damaged by a high working power.

For easy understanding of the invention, the following is the description of adjusting the charging current of the charging device.

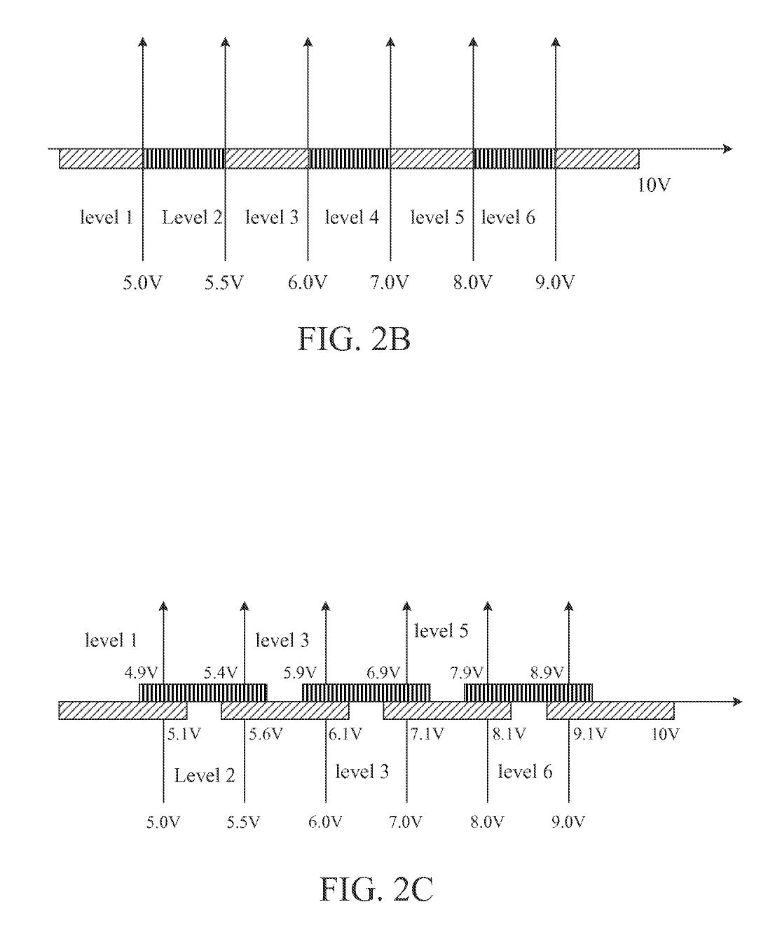

FIG. 2A is a flow diagram of a charging control method of a second embodiment according to the invention. The embodiment adjusts the charging current of the charging device according to the charging voltage. More specifically, the charging control method of the embodiment comprises the following steps.

At a step 201, the charging voltage of the charging device is monitored.

At a step 202, a corresponding charging current is determined according to the relationship between the charging voltage and the charging current.

At a step 203, the charging current of a charging device is adjusted to the corresponding charging current to maintain working power of the charging device to be within a predetermined power range.

The embodiment adjusts the charging current of the charging device according to the real-time monitored charging voltage to maintain the working power of the charging device to be within a predetermined power range.

In an application, assume that the maximum current flowing through the charging device is Imax, the battery voltage is Vbat (in this embodiment, the rated voltage of the battery is 3.4 V); the maximum power consumption is Ptot (in this embodiment, the maximum power consumption is 1.2 W), i.e. the rated power consumption of the charging device, and a parameter a is a power degrading parameter of the charging device. According to the equation Imax=a*Ptot/(Vchr−3.4), when the parameter “a” is a constant value (a=1 in this embodiment), the charging current is limited to Ptot and Vchr, Thus, the higher the charging voltage is, the lower the Imax is.

For example, the minimum charging voltage Vchr is 5V, and Imax=1.2 W/(5 V−3.4 V)=750 mA. In the traditional charging method, the charging voltage variation is not considered, and when the portable devices like cell phones are plugged into the charging device, the charging current is maintained at 750 mA, and the working power of the charging device is higher than the rated power, which may cause damage to the charging device and the portable device.

In this embodiment, the charging current of the charging device is automatically adjusted according to the charging voltage to maintain the working power of the charging device to be within a predetermined power range to prevent the equipments from being damaged. For example, when the charging voltage is 6V, Imax=Ptot/(Vchr−3.4) is adjusted to 460 mA to prevent the equipments from being damaged.

In this embodiment, a corresponding charging current of the charging voltage can be determined according to the relationship between the charging voltage and the charging current. More specifically, a predetermined V-I (voltage-to-current) table is set to establish the relationship between the charging voltage and the charging current, wherein the V-I table comprises a plurality of voltage levels, and each of the voltage levels is matched to a corresponding current level.

For example, table 1 is a predetermined V-I table comprising a plurality of voltage levels, and each of the voltage levels is matched to a corresponding current level.

TABLE 1

| | Charging Voltage | Charging Current |
|---|---|---|
| Level | (V) | (mA) |
| (level 1) | 5 | 750 |
| (level 2) | 5.5 | 570 |
| (level 3) | 6 | 460 |
| (level 4) | 7 | 330 |
| (level 5) | 8 | 260 |
| (level 6) | 9 | 200 |

In the table 1, each of the voltage levels is matched to a corresponding current level, wherein the level 1 is a voltage range which is equal to or smaller than 5V, and the level 2 is a voltage range between 5 V and 5.5 V, and so on. When a charging voltage is detected, a corresponding charging current can be determined For example, when the charging current Vchr=5.7 V, the corresponding charging current of the charging voltage is 460 mA. Although the above example provides six voltage levels, any number of voltage levels and any voltage level ranges can be set according to desired requirements.

In this embodiment, when the charging voltage is smaller than 5V, the corresponding charging current is 750 mA. The higher the charging voltage is, the lower the charging current is. When the charging voltage is the voltage level between 8V and 9V, the charging current is 200 mA, and when the charging voltage exceeds 9V, the charging procedure can be ended.

The V-I table in this embodiment is a customized method of determining the current by storing the V-I table, and then determining the charging current by looking up the V-I table in a fast and easy way.

To conclude, the embodiment adjusts the charging current of the charging device according to the charging voltage to maintain the working power of the charging device to be within a predetermined power range, and prevents the charging device from being damaged by a high working power. The embodiment is suitable for different charging voltage levels, and the portable device can be connected to charging devices with different output voltages. The portable devices in the invention do not need an independent charging device, and the flexibility of the portable devices is improved.

In this embodiment, the charging current corresponding to the charging voltage can also be determined dynamically by the Equation I=Ptot/(Vchr −3.4), and the charging device can be adjusted according to the results to maintain the working power of the charging device to be within a predetermined range.

In this embodiment, to prevent the charging current from fluctuation due to the charging voltage variation of the charging device, the charging current can be adjusted periodically when monitoring the charging voltage. This way, a charging current adjustment is made after a certain time period, which prevents frequent current adjustment. More specifically, multiple charging voltage levels can be detected within a predetermined time period. This way, a charging current adjustment is made after a certain time period to prevent unstable current caused by frequent current adjustment. In an application, the predetermined time period is set according to design requirements, for example, 500 ms or 1 s.

Further, before adjusting the charging current of the charging devices, the deviation of the charging voltage can be determined When the deviation of the charging voltage exceeds a predetermined threshold value, the charging current of the charging devices is adjusted. For example, when the charging voltage changes repeatedly between two voltage levels of the Table 1, the charging current can be set to be the larger charging current to perform charging to prevent frequent adjustment. In this embodiment, the method is called a hysteresis function. FIGS. 2B and 2C indicates the configurations of the charging levels with and without hysteresis function. The charging control with hysteresis function in FIG. 2C prevents frequent adjustments of the charging current when the voltage changes repeatedly between two voltage levels.

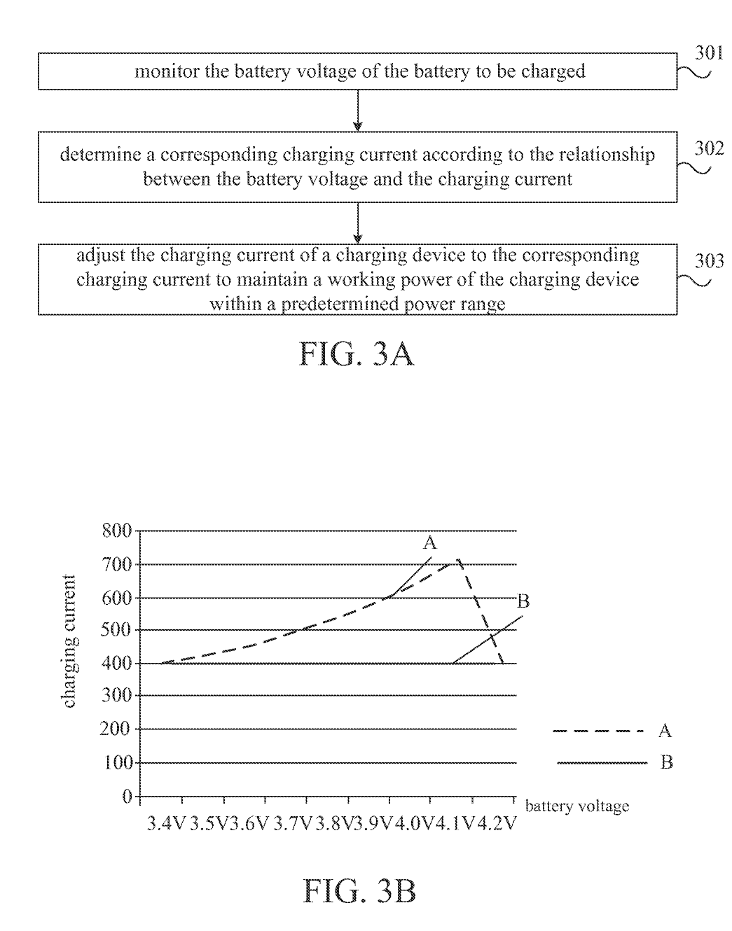

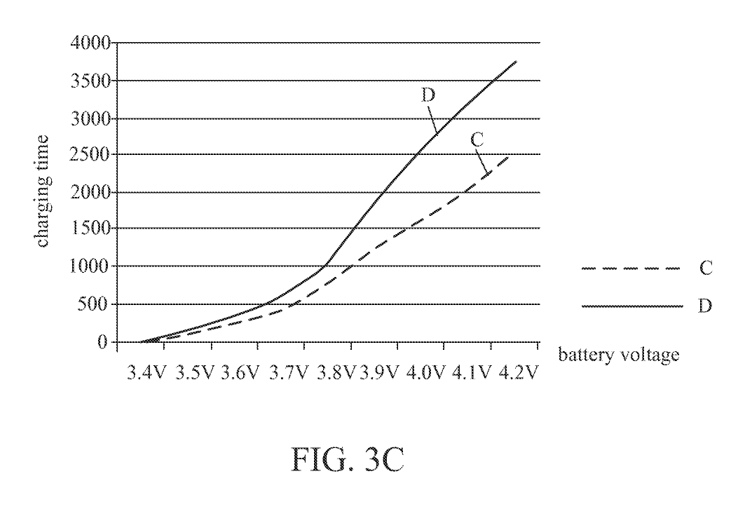

FIG. 3A is a flow diagram of the charging control method provided in a third embodiment according to the invention. The embodiment adjusts the charging current according to the battery voltage. More specifically, the charging control method of the embodiment in FIG. 3A comprises the following steps.

At a step 301, the battery voltage of the battery to be charged is monitored.

At a step 302, a corresponding charging current is determined according to the relationships between the battery voltage and the charging current.

At a step 303, the charging current of a charging device is adjusted to the corresponding charging current to maintain a working power of the charging device to be within a predetermined power range.

The embodiment adjusts the charging current of the charging device according to the real-time monitored battery voltage to maintain the working power of the charging device to be within a predetermined power range when the charging voltage is a fixed value, which raises the charging speed and provides a high efficiency of battery charging.

During the battery charging period, battery voltage increases as the charging time increases. Therefore, through detecting of the battery voltage and adjusting the charging current of the charging device according to the battery voltage level, the power of the charging device can be maintained within a predetermined power range, to keep the charging efficiency of the charging device at a higher level and to improve the charging speed.

In an application, assume the maximum current flowing through the charging device is Imax, the voltage applied to the charging device from external circuits or charging devices is Vchr (in this embodiment, the charging voltage Vchr is 5V), the battery voltage is marked as Vbat, the maximum power consumption is Ptot (in this embodiment, the maximum power consumption is 0.64 W), i.e. the rated power consumption of the charging device, and a is a power degrading parameter of the charging device. According to an equation Imax=a*Ptot/(Vchr −3.4), when the parameter “a” is a constant value (a=1 in this embodiment), the charging current is limited to the maximum power consumption Ptot and the battery voltage Vbat. Thus, the smaller the battery voltage is, the lower the maximum current Imax is.

For the traditional way of charging with a constant current, the variation of the battery voltage Vbat is not considered, therefore the maximum current Imax=0.64 w/(5v−3.4v)=400mA. The charging current of the charging device Imax is maintained at a level of 400 mA. According to the Equation of Imax=a*Ptot/(5−Vbat), we know that the value of the maximum power consumption Ptot decreases gradually. In this embodiment, the charging current is adjusted according to the battery voltage, and the charging device works at the maximum power level, which raises the charging speed.

In this embodiment, a corresponding charging current can be determined according to the relationship between the battery voltage and the charging current. More specifically, a predetermined V-I table is set to establish the relationship between the battery voltage and the charging current, wherein the V-I table comprises a plurality of voltage levels, and each of the voltage levels is matched to a corresponding current level.

For example, Table 2 is a predetermined V-I table comprising a plurality of voltage levels, and each of the voltage levels is matched to a corresponding current level.

TABLE 2

| | Battery Voltage | Charging Current |
|---|---|---|
| Level | (V) | (mA) |
| (level 1) | 3.4 | 400 |
| (level 2) | 3.5 | 424 |
| (level 3) | 3.6 | 456 |
| (level 4) | 3.7 | 492 |
| (level 5) | 3.8 | 532 |
| (level 6) | 3.9 | 580 |
| (level 7) | 4 | 640 |
| (level 8) | 4.1 | 708 |
| (level 9) | 4.2 | 400 |

In table 2, each of the voltage levels is matched to a corresponding current level. Wherein the level 1 is a voltage range which is equal to or smaller than 3.4V; and the level 2 is a voltage range between 3.4 V and 3.5 V, and so on. When a battery voltage is detected, a corresponding charging current can be determined For example, when the battery voltage Vbat=3.65 V, the corresponding charging current is 456 mA. Although the above example provides nine voltage levels, any number of voltage levels and any voltage level range can be set according to design requirements.

In this embodiment, when the battery voltage is smaller than 3.4V, the corresponding charging current is 400 mA. The higher the battery voltage is, the lower the charging current is. When the battery voltage exceeds 4.1V, the charging current will be maintaining at 400 mA because of a charging saturation rate, that is, a full rate.

FIG. 3B is a schematic view of charging current comparisons between traditional constant current charging method and the charging method provided in this embodiment according to the invention. FIG. 3C is a schematic view of charging time comparisons between a traditional charging method with a constant current and the charging method provided in this embodiment according to the invention. As shown in FIG. 3B, the curve A is the current trend when applying the charging method utilizing the Table 2; the curve B is the current trend when applying the traditional charging method with a constant current. As shown in FIG. 3C, the curve C is the time trend when applying the charging method utilizing the Table 2; the curve D is the time trend when applying the traditional charging method with a constant current. From FIGS. 3B and 3C, it is shown that the method of the embodiment requires 2500 seconds to charge the battery voltage to 4.2V, and the traditional charging method requires 3700 seconds to charge the battery voltage to 4.2V., In comparison with the traditional charging method, the method of the embodiment decreases the charging time by 32%, which greatly increases the battery charging speed.

This embodiment provides a customized way to acquire current according to the Table 2 by first storing the V-I relationship, and then determining the charging current by referring to the look-up table. This way of acquiring current is simple and fast.

To conclude, the embodiment adjusts the charging current of the charging device according to the battery voltage to maintain the working power of the charging device to be within a predetermined power range, and prevent the charging device from being damaged by a high working power.

In an application, the charging current corresponding to the charging voltage can also be determined by the Equation I=Ptot/(Vchr −3.4)*PDegrading, wherein the parameter PDegrading is a degrading factor of the charging device considering various causes, and the parameter PDegrading is a constant value. The charging device can also be adjusted according to the Equation to maintain the working power of the charging device to be within a predetermined range according to the equation. In this embodiment, to prevent the charging current from fluctuation due to the charging voltage variation of the charging device, the charging current can be set to be adjusted periodically when monitoring the battery voltage. This way, a charging current adjustment is made after a certain time period, which prevents frequent current adjustment. The concept of this embodiment is similar to the method of periodically adjusting the charging current according to the charging voltage.

Further, before adjusting the charging current of the charging devices, the deviation of the battery voltage can be determined to adjust the charging current of the charging devices when the deviation of the battery voltage exceeds a predetermined threshold value. The concept of this embodiment is similar to the method of embodiments provided above.

One with ordinary skill in the art may understand that one might adjust the charging current of the charging device according to the detected battery voltage and the detected charging voltage. More specifically, the battery voltage and the charging voltage can be detected simultaneously, and the charging current I can be adjusted according to the equation I=Ptot/(Vchr−Vbat) when Ptot is a fixed value. This application is suitable for the conditions with larger charging voltage variation, and ensures the charging efficiency of the charging device. The concept of this embodiment is similar to the method of the embodiments provided above.

One with ordinary skill in the art may understand that the adjustment of the charging current in the second or third embodiment is the adjustment of the magnitude of the charging current of the charging device to ensure that the working power of the charging device is within a predetermined power range. In an application, in order to ensure the working power of the charging device is within a predetermined power range, except for adjusting the charging current according to the battery voltage and/or the charging voltage, the duty cycle of the charging current can also be a factor for adjusting the charging current to maintain the working power of the charging device. For example, adjusting the duty cycle of the charging current is dynamically adjusted according to the charging voltage, the battery voltage, or the difference between the charging voltage and the battery voltage, to maintain the working power of the charging device.

The followings are examples of the invention of adjusting the duty cycle of the charging current of the charging device.

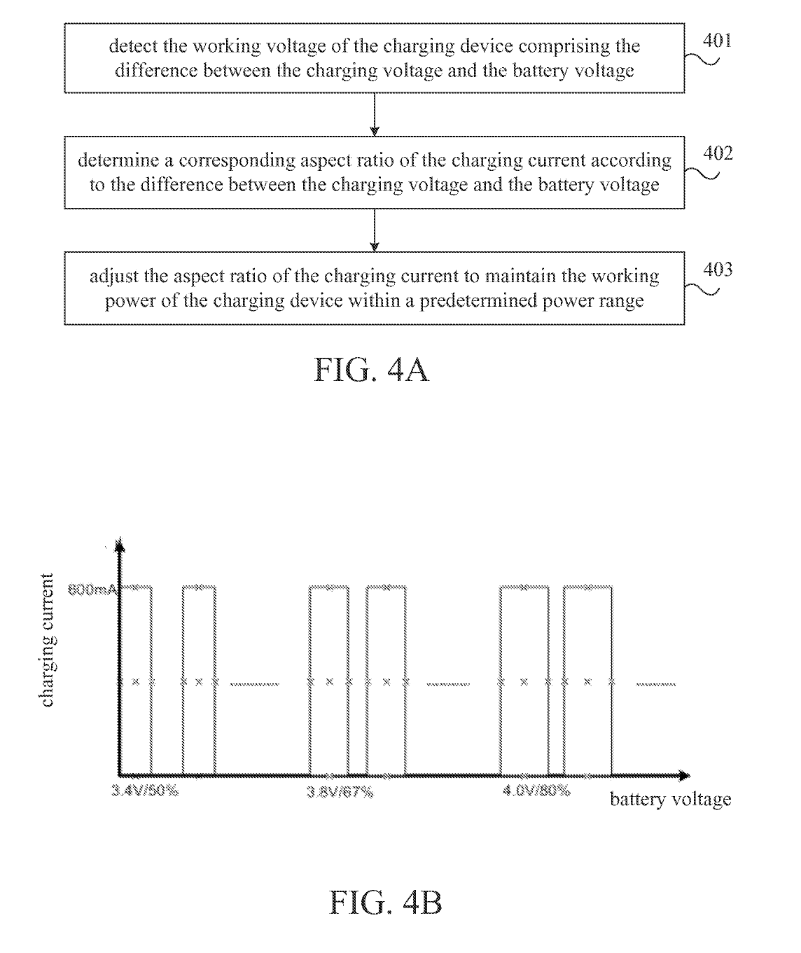

FIG. 4A is a flow diagram of a charging control method in a fourth embodiment according to the invention. In this embodiment, the duty cycle of the charging current of the charging device is adjusted according to the detected charging voltage and the detected battery voltage. The duty cycle of the charging current is adjusted to maintain the working power of the charging device without altering the magnitude of the charging current. More specifically, the charging control method of the embodiment in FIG. 4A comprises the following steps:

At a step 401, the working voltage of the charging device comprising the difference between the charging voltage and the battery voltage is detected.

At a step 402, a corresponding duty cycle of the charging current is determined according to the difference between the charging voltage and the battery voltage.

At a step 403, the duty cycle of the charging current is adjusted to maintain the working power of the charging device to be within a predetermined power range.

In this embodiment, the duty cycle of the charging current is adjusted to maintain the working power of the charging device to be within a predetermined power range without altering the magnitude of the charging current. This results in increased flexibility of the charging current adjustment.

In an application, assuming the maximum current of the charging device is Imax, the charging voltage applied to the charging device is set to Vchr, the battery voltage is Vbat, and the maximum power of the charging device is Ptot. The power of the charging device P=(Vchr−Vbat)*Imax, and the charging current is determined according to Ptot, Vchr, and Vbat. If the charging current is a pulse-width modulated current, then P=(Vchr−Vbat)*Imax*Ipwm, wherein Ipwm is the duty cycle of the current Imax.

When Imax is in a constant level, the duty cycle of the current (i.e. Ipwm) is adjusted to control the power consumption of the charging device, to maintain the power of the charging device to be within a predetermined power range. For example, when the minimum charging voltage Vchr is 5V, the maximum battery voltage Vbat is 4V, and the duty cycle of the current is 1, and the maximum Imax=1200 mA. The higher the charging voltage is, the smaller the maximum current Imax is. Assuming that the minimum charging voltage Vchr is 5V, the maximum power consumption Ptot is 1.2W, and the minimum voltage of the battery is 3.4V, then Imax=1.2 W/(5V-3.4V)=750 mA.

When applying the traditional charging method with a constant current, variations of the charging voltage and the battery voltage are not considered, and the charging current is a fixed value of 750 mA even when a portable device is plugged into a high voltage charging device. Thus the power exceeds the predetermined power Ptot, which may cause damage to devices. The pulse width modulated current control method adjusts the power consumption of the charging device by altering the duty cycles of the charging device to protect the charging device.

FIG. 4B is a schematic view of V-I relationship when adjusting charging current by tuning the duty cycle of the charging current. In FIG. 4B, the x-axis indicates the battery voltage, and the y-axis indicates the charging current. When the charging voltage remains the same, the current duty cycle changes with different battery voltages. When Vchr=5V, the charging current is 600 mA, Vbat=3.4V, and duty cycle of the charging current Ipwm=50%. As the charging process continues, when the battery voltage Vbat reaches 3.8V, the duty cycle Ipwm is set as 67%. When the battery voltage Vbat=4.0 V, the duty cycle is adjusted to 80%. To conclude, the higher the battery voltage is, the larger the duty cycle of the charging current is. Thus, the average power consumption of the charging device is maintained within a predetermined power range.

As stated above, this embodiment adjusts the duty cycle of the charging current to maintain the working power to be within a predetermined power range, which can prevents the charging device from being damaged by a large power fluctuation.

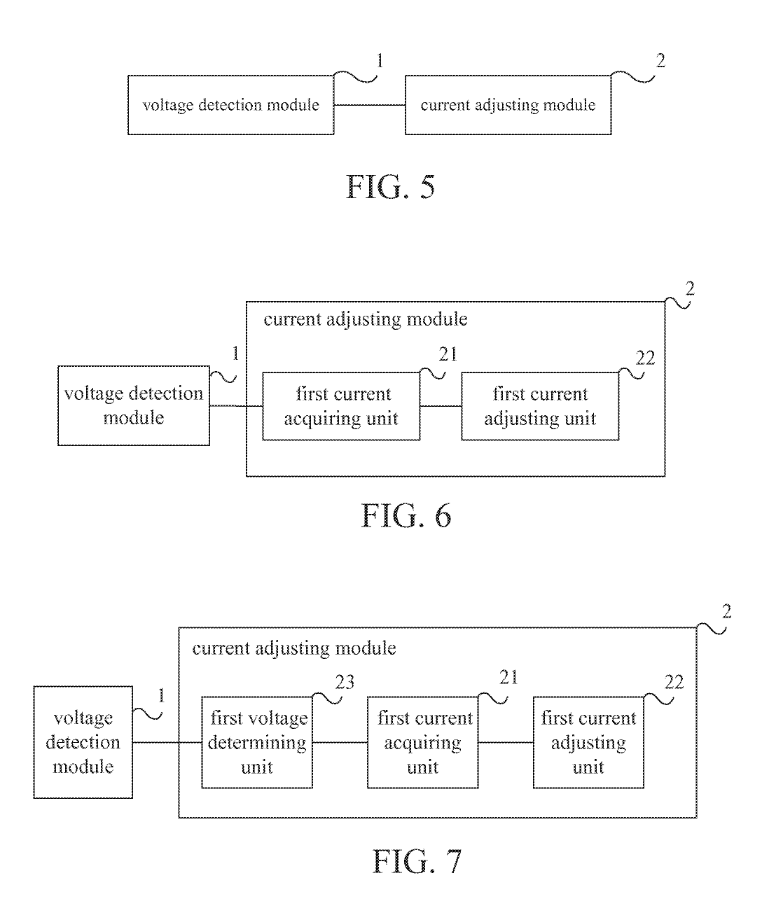

FIG. 5 is a schematic view of the structure of the charging device in a fifth embodiment according to the invention. As shown in FIG. 5, the charging control device comprises a voltage detection module 1 and a current adjusting module 2, wherein:

The voltage detection module 1 is for detecting the working voltage of the charging device, wherein the working voltage of the charging device comprises the difference between the charging voltage and the battery voltage.

The current detecting module 2 is utilized for adjusting the charging current of the charging device dynamically according to the working voltage of the charging device.

The embodiment may be applied in portable devices to adjust the charging current of a charging device, in order to maintain the working power of the charging device to be within a predetermined power range. The details of this embodiment are similar to other embodiments disclosed above.

FIG. 6 is a schematic view of the charging control device of a sixth embodiment according to the invention. As shown in FIG. 6, a voltage detection module 1 detects the charging voltage; and a current detecting module 2 detects the charging current. The current adjusting module 2 comprises a first current acquiring unit 21 and a first voltage adjusting unit 22, wherein:

The first current acquiring unit 21 is utilized for acquiring a corresponding charging current of the charging voltage according to the relationship between the charging current and the charging voltage.

The first voltage adjusting unit 22 is for adjusting the charging current of the charging device to the corresponding charging current of the charging voltage.

In this embodiment, to acquire the corresponding charging current of the charging voltage, the first current acquiring unit 21 can be implemented with a predetermined table containing the relationships between the charging voltage and the charging current for acquiring the corresponding charging current of the charging voltage by referring to the table, wherein each voltage level corresponds to a charging current value.

In this embodiment, to prevent the charging current from frequent adjustment, the charging current can be set to be adjusted periodically. More specifically, the voltage detection module 1 can be used to detect multiple charging voltage values within a predetermined time period, and set the average of the multiple charging voltage values as the charging voltage. The current adjusting module 2 then adjusts the charging current according to the charging voltage.

The charging control device of the invention adjusts the charging current according to the charging voltage, and the details of the adjustment are similar to the second embodiment according to the invention.

FIG. 7 is the schematic view of the charging control device provided in the seventh embodiment according to the invention. The difference between the sixth embodiment and the seventh embodiment is that the current adjusting module 2 further comprises a first voltage determining unit 23, wherein the first voltage determining unit 23 detects the variation of the charging voltage. The first current adjusting unit 22 is used to adjust the charging current when the deviation of the charging voltage exceeds a threshold value.

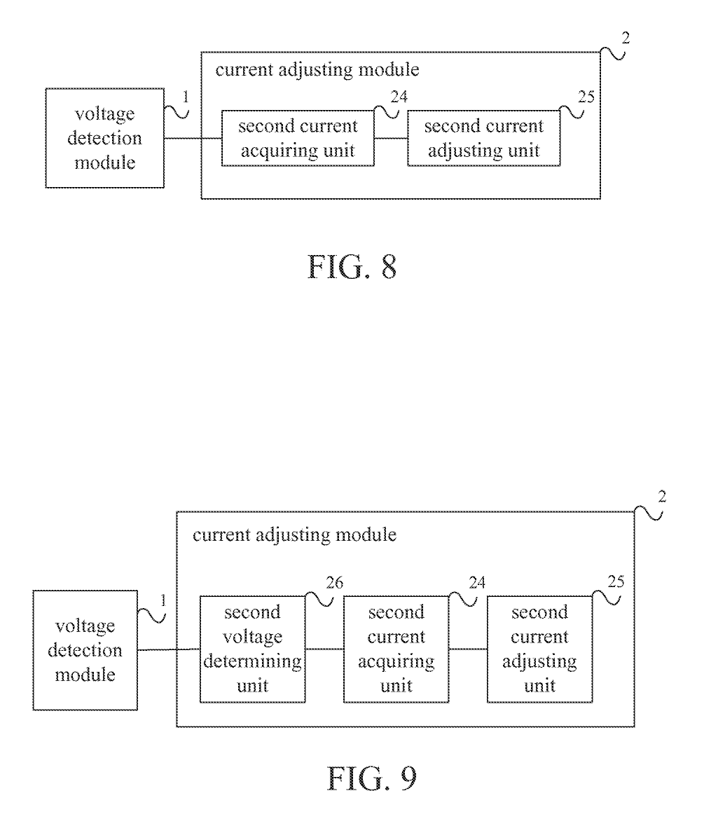

FIG. 8 is a schematic view of the structure of a charging control device. The charging control module 2 shown in FIG. 8 comprises a voltage detection module 1 for detecting a battery voltage, and a current adjusting module 2 for adjusting the charging current of the charging device according to the battery voltage. The current adjusting module 2 comprises a second current acquiring unit 24 and a second current adjusting unit 25, wherein the second current acquiring unit 24 acquires a corresponding charging current of the charging voltage according to the relationship between the battery voltage and the charging current. The second current adjusting unit 25 adjusts the charging current according to the battery voltage.

In this embodiment, to acquire the corresponding charging current, the second current acquiring 24 refers to a predetermined V-I table to acquire the corresponding charging current of the battery voltage, wherein the V-I table comprises multiple levels, and each of the levels corresponds to a charging current value.

In this embodiment, to prevent frequent charging current adjustment, the charging current is set to be adjusted periodically. More specifically, the battery detecting module 1 is used to detect the average of the battery voltage within a predetermined time period, and the current adjusting module 2 sets the battery voltage according to the average voltage.

The charging control device in this embodiment adjusts the charging current according to the charging voltage. The details are similar to the third embodiment according to the invention.

FIG. 9 is a schematic view of a charging control device of a ninth embodiment according to the invention. The difference between the embodiment in FIG. 9 and the embodiment of FIG. 8 is that the current adjusting module 2 in this embodiment further comprises a second voltage determining unit 26. The second voltage determining unit 26 is for detecting the variations of the battery voltage. When the deviation of the battery voltage exceeds a predetermined threshold value, the second current adjusting unit 25 adjusts the corresponding charging current according to the battery voltage.

In addition, in this embodiment of the charging control device shown in FIG. 5, the current adjusting module 2 further adjusts the duty cycle of the charging current according to the working voltage obtained by the voltage detection module 1, and maintains the working power of the charging device to be within a predetermined power range. The details of this embodiment are similar to the fourth embodiment described above. In certain conditions, the charging voltage and the battery voltage can be set to a constant value, and the working voltage comprises the difference between the charging voltage and the battery voltage. When the charging voltage is constant, the method can be simplified to adjust the charging current according to the battery voltage; and when the battery voltage is constant, the method can be simplified to adjusting the charging current according to the charging voltage.

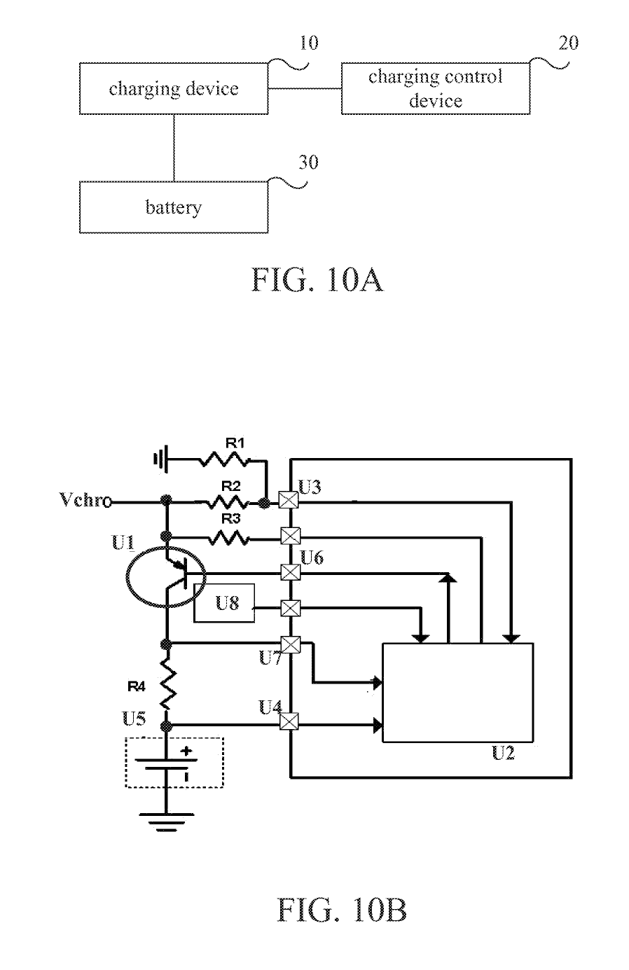

FIG. 10A is a schematic view of a charging system of an eleventh embodiment according to the invention. FIG. 10B is an equivalent circuit diagram of the charging system in FIG. 10A. As shown in FIG. 10A, the charging system comprises a charging device 10 and a charging control device 20, and the charging device 10 is connected to the charging control device 20, wherein the charging device 10 is connected to the power source and the battery 30, and the charging device 10 is used to charge the battery 30. The charging control device 20 detects the working voltage of the charging device 10, and adjusts the charging current of the charging device 10 according to the charging voltage and/or the battery voltage to maintain the working power to be within a predetermined power range. The working voltage comprises the difference between the charging voltage and the battery voltage.

In this embodiment, the charging device 10 is connected to an external power source. For example, the charging voltage is provided by the charging device to charge the battery by applying the charging voltage. In the process of battery charging, the charging control device 20 adjusts the charging current of the charging device 10 according to the working voltage of the charging power to maintain the working power of the charging device to be within a predetermined power range.

In this embodiment, as shown in FIG. 10B, the charging device 10 is marked as U1, and the input terminal of the U1 is connected to power Vchr, and the output terminal of the U1 is connected to a battery U5 via a resistor R4. The controller U2 may be the charging control device 20 monitoring the charging voltage and the battery voltage via the voltage sensing units U3 and U4. The voltage sensing unit U3 is connected to the power Vchr via a resistor R2, and the voltage sensing unit U3 is connected to ground via a resistor R1, and the controller U2 adjusts the current of the U1 via a current sensing unit U7. The adjusting unit U6 can be a current control chip, and the voltage sensing units U3, U4 and the adjusting unit U6 can be integrated into the controller U2. Further, the controller U2 is connected to the U1 according to the current sensing unit U7 to monitor the current of U1. A temperature sensor U8 can also be integrated into the U1 to monitor the working power of the U1, and controls the U1 according to the detected current and power to prevent from overcurrent or overheating. Also, other units may be implemented, for example, a resistor R3 may be between the controller U2 and the adjusting unit U6. In this embodiment, the charge control device 20 can be the charge control device described in any of the embodiments. Reference can be made to the embodiments provided above for the structure and function of the charge control device.

Moreover, the invention provides a portable device comprising a charging control device. The portable device includes a charging system for charging the battery of the portable device. The charging system can be the charging system provided in FIGS. 10A and 10B.

The portable devices in the embodiments can be a cell phone, a PDA, or a tablet computer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A charging control method for adjusting a charging current of a charging device, comprising:
monitoring a working voltage of the charging device, wherein the working voltage comprises a voltage difference between a charging voltage and a battery voltage; and
adjusting the charging current of the charging device dynamically according to the working voltage of the charging device to maintain a working power of the charging device to be within a predetermined power range.

2. The charging control method as claimed in claim 1, wherein when the battery voltage is set to a fixed voltage level, the step of dynamically adjusting the charging current of a charging device according to the working voltage of the charging device further comprise:
determining a corresponding charging current of the charging voltage according to the relationships between the charging voltage and the charging current; and
adjusting the charging current of the charging device to the corresponding charging current of the charging voltage.

3. The charging control method as claimed in claim 2, wherein the step of determining the corresponding charging current of the charging voltage according to the relationships between the charging voltage and the charging current comprises:
determining the corresponding charging current of the charging voltage by referencing a predetermined look-up table storing the relationships between the charging voltage and the charging current, wherein
the predetermined look-up table comprises a plurality of voltage levels, and each of the voltage levels corresponds to a charging current level.

4. The charging control method as claimed in claim 2, wherein the step of monitoring a working voltage of the charging device further comprises:
monitoring a plurality of charging voltage levels within a predetermined time period; and
setting an average of the charging voltage levels as the charging voltage.

5. The charging control method as claimed in claim 2, wherein before the step of adjusting the charging current of the charging device dynamically according to the working voltage of the charging device, the charging control method further comprises:
determining a deviation of the charging voltage and adjusting the charging current of the charging device when the deviation of the charging voltage exceeds a deviation value threshold.

6. The charging control method as claimed in claim 1, wherein when the charging voltage is a fixed voltage level, the step of dynamically adjusting the charging current of a charging device according to the working voltage of the charging device further comprises:
determining a corresponding charging current of the battery voltage according to the relationships between the battery voltage and the charging current; and
adjusting the charging current of the charging device to the corresponding charging current of the battery voltage.

7. The charging control method as claimed in claim 6, wherein the step of determining the corresponding charging current of the battery voltage according to the relationships between the battery voltage and the charging current comprises:
determining the corresponding charging current of the battery voltage by referencing a predetermined look-up table containing the relationships between the battery voltage and the charging current, wherein
the predetermined look-up table comprises a plurality of voltage levels, and each of the voltage levels corresponds to a charging current level.

8. The charging control method as claimed in claim 6, wherein the step of monitoring a working voltage of the charging device further comprises:
monitoring a plurality of battery voltage levels within a predetermined time period; and
setting the battery voltage as an average of the plurality of the battery voltage levels.

9. The charging control method as claimed in claim 6, wherein, before the step of adjusting the charging current of the charging device dynamically according to the working voltage of the charging device, the charging control method further comprises:
determining a deviation of the battery voltage and adjusting the charging current of the charging device when the deviation of the battery voltage exceeds a deviation value threshold.

10. The charging control method as claimed in claim 1, wherein the step of dynamically adjusting the charging current of a charging device according to the working voltage of the charging device further comprises:
adjusting a duty cycle of the charging current of the charging device dynamically according to the charging voltage, the battery voltage, or the voltage difference between the charging voltage and the battery voltage.

11. A charging control device, comprising:
a voltage detection module, monitoring a working voltage of the charging device, wherein the working voltage comprises a voltage difference between a charging voltage and a battery voltage; and
a current adjusting module, dynamically adjusting a charging current of a charging device according to the working voltage of the charging device.

12. The charging control device as claimed in claim 11, wherein when the battery voltage is set to a fixed voltage level, the voltage detection module detects the charging voltage; and
the current adjusting module adjusts the charging current of a charging device dynamically according to the charging voltage of the charging device, wherein the current adjusting module comprises:
a first current acquiring unit, determining a corresponding charging current of the charging voltage according to a relationship between the charging voltage and the charging current; and
a first current adjusting unit, adjusting the charging current of a charging device to the corresponding charging current of the charging voltage.

13. The charging control device as claimed in claim 12, wherein the first current acquiring unit determines the corresponding charging current of the charging voltage by referencing a predetermined look-up table storing the relationship between the charging voltage and the charging current; wherein
the predetermined look-up table comprises a plurality of voltage levels, and each of the voltage levels corresponds to a charging current level.

14. The charging control device as claimed in claim 12, wherein the voltage detection module monitors a plurality of charging voltage levels in a predetermined time period, and sets the average of the charging voltage levels as the charging voltage.

15. The charging control device as claimed in claim 12, wherein the current adjusting module further comprises:
a first voltage determining unit, determining a deviation of the charging voltage;
wherein when the deviation of the charging voltage exceeds a deviation value threshold, the first current adjusting unit adjusts the charging current of the charging device to the corresponding current of the charging voltage.

16. The charging control device as claimed in claim 11, wherein when the charging voltage is set to a fixed voltage level, the voltage detection module detects the battery voltage; and
the current adjusting module adjusts the charging current of the charging device dynamically according to the battery voltage of the charging device, wherein the current adjusting module comprises:
a second current acquiring unit, determining the corresponding charging current of the battery voltage according to a relationship between the battery voltage and the charging current; and
a second current adjusting unit, adjusting the charging current of the charging device to the corresponding charging current of the battery voltage.

17. The charging control device as claimed in claim 16, wherein the voltage detection module is utilized for monitoring a plurality of battery voltage levels in a predetermined time period and sets the battery voltage as an average of the plurality of the battery voltage levels.

18. The charging control device as claimed in claim 16, wherein the current adjusting module further comprises:
a second voltage determining unit to determine a deviation of the battery voltage,
wherein the second current adjusting unit adjusts the charging current of the charging device dynamically to the corresponding charging current of the battery voltage when the deviation of the battery voltage exceeds a deviation value threshold.

19. The charging control device as claimed in claim 11, wherein the current adjusting module dynamically adjusting the charging current of a charging device according to the working voltage of the charging device further comprises:
adjusting a duty cycle of the charging current of the charging device dynamically according to the charging voltage, the battery voltage, or the difference between the charging voltage and the battery voltage, to maintain a working power of the charging device to be within a predetermined power range.

20. A charging system, comprising a charging device and the charging control device as claimed in claim 11 connecting to the charging device.
